(19) United States
(12) Patent Application Publication
(10) Pub. No.: US 2026/0029906 A1
(43) Pub. Date: Jan. 29, 2026

(54) SYSTEM AND METHOD FOR SPATIAL COHORT MAPPING AND ANALYSIS

(71) Applicant: THE CHILDREN’S MERCY HOSPITAL, Kansas City, MO (US)

(72) Inventors: Mark A. HOFFMAN, Lee’s Summit, MO (US); Kevin Matthew POWER, Kansas City, MO (US); Natalie June KANE, Kansas City, MO (US); Harpreet Singh GILL, Olathe, KS (US); Jared JOHNSON, Kansas City, MO (US); Kushal Kumar VALLAMBHATLA, Shawnee, KS (US); Catherine Anne JACKSON, Shawnee, KS (US)

(21) Appl. No.: 19/280,457

(22) Filed: Jul. 25, 2025

Related U.S. Application Data
(60) Provisional application No. 63/675,494, filed on Jul. 25, 2024.

(51) Int. Cl. G06F 3/04845; G06F 3/0485; G06F 3/0488

(52) U.S. Cl. CPC G06F 3/04845; G06F 3/0485; G06F 3/0488; G06F 2203/04806

(57) ABSTRACT

A system and computer-implemented method for tandem map displays, including displaying both a first and a second dynamic map image, each represent a first geographic area, on a screen, and displaying on the first and the second dynamic map images a plurality of geocoded data points, each at a particular geographic coordinate within the first geographic area. The method also includes displaying a first set of characteristics associated with geographic subsets of the first geographic area in the first dynamic map image and displaying a second set of characteristics associated with the geographic subsets of the first geographic area in the second dynamic map image, as well as receiving a user manipulation within the first or second dynamic map images. Based on the user manipulation, both the first and the second dynamic map images are simultaneously adjusted to each represent a second geographic area based on the user manipulation.

### CROSS-REFERENCE TO RELATED APPLICATIONS

The present application claims the priority benefit of U.S. Provisional Patent Application Ser. No. 63/675,494, filed Jul. 25, 2024, entitled SYSTEM AND METHOD FOR SPATIAL COHORT MAPPING AND ANALYSIS, and incorporated by reference in its entirety herein.

### STATEMENT REGARDING FEDERALLY-SPONSORED RESEARCH OR DEVELOPMENT

This invention was made with government support under TR002366 awarded by the National Institutes of Health. The government has certain rights in the invention.

### BACKGROUND

Data associated with specific geographic locations can be graphically depicted using a variety of colors and symbols on a map displayed on a user interface. Furthermore, when there are a plurality of types of data, some user interfaces or software programs are configured to layer multiple types of data onto the map, such as by layering multiple types of data over the map. However, when too many types of data are displayed on a map at the same time via the user interface, important information can be visually obscured or overcrowded, which can be visually difficult for a user to interpret and analyze. It is particularly difficult to compare data that would be displayed in multiple, overlapping layers.

### SUMMARY

The present disclosure addresses one or more of the above-mentioned problems and provides a distinct advance in the art of spatial cohort mapping and analysis. A cohort, as used herein, may refer to a group of people, places, or events, usually having a shared characteristic(s), and associated with a specific location (e.g., a specific geographic location, such as latitude and longitude). In one or more embodiments, based on user input and one or more data sources or databases, various data about a cohort and a particular geographic area can be visually compared in tandem. For example, a first dynamic map image and a second dynamic map image may both be displayed on a graphical user interface (GUI). The first and the second dynamic map images may display a first geographic area and a plurality of geocoded data points each at a particular geographic coordinate within the first geographic area. When a user selects a magnifying icon or a panning icon (or otherwise provides a gesture via a trackpad or touchscreen for magnifying or panning), the user can direct the first dynamic map image or the second dynamic map image to either zoom into a subregion within the first geographic area or to pan to a second geographic area, and that zooming and/or panning may simultaneously occur on both the first dynamic map image and the second dynamic map image in tandem. That is, based on this user direction, both of the dynamic map images are identically adjusted to display the second geographic area. Furthermore, side-by-side comparison tables may be displayed and dynamically updated based on user selection within one of the dynamic map images and/or user input within one of the comparison tables.

The GUI may also display a first set of characteristics associated with geographic subsets of the first geographic area in the first dynamic map image while displaying a different second set of characteristics associated with the geographic subsets of the first geographic area in the second dynamic map image. Thus, when the GUI receives user selections causing the zooming or panning described above, the first set of characteristics and the second set of characteristics associated with geographic subsets of the second geographic area are shown in the first and second dynamic map images, respectively. This tandem manipulation of at least two different dynamic map images (such that the geographic area displayed and/or geographic locations of data points in a cohort displayed may remain identical), while each of the dynamic map images simultaneously also display different types of characteristics associated with geographic subsets within the geographic area, allows for geographic inference (e.g., dynamic visual analysis and comparison of two, three, or more data sets) within a selected geographic area without overlapping too many types of data or obscuring important information.

This summary is provided to introduce a selection of concepts that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

The patent or application file contains at least one drawing executed in color. Copies of this patent or patent application publication with color drawing(s) will be provided by the Office upon request and payment of the necessary fee. Embodiments are described in detail below with reference to the attached drawing figures, wherein:

FIG. 1 is a block diagram of a system constructed in accordance with an embodiment of the present invention;

FIG. 2 is a flow chart in accordance with a computer-implemented method of an embodiment of the present invention;

FIG. 3 is a screenshot of tandem dynamic map images presented via the app or computer program described herein, depicting different pop-ups indicating specific information for a highlighted subregion;

FIG. 4 is a screenshot of a comparison table presented via the app or computer program;

FIG. 5 is an example code segment for operating various aspects of the app or computer program described herein, including an innovative logical encoding format used by the app to enable geographical data movement within the app;

FIG. 6 depicts map gradient options for user customization stored as a keyed collection of hex value color arrays;

FIG. 7 is a flow diagram depicting a process used by the app to upload a geocoded or geocoded file of individual cohort participant locations as a collection of latitudes and longitudes;

FIG. 8 is a screenshot depicting a user selection of a new file to upload in a menu on the left;

FIG. 9 is a screenshot depicting a user selection of a geography input or geographic area of either counties or census tracks to be analyzed;

FIG. 10 is a flow diagram depicting a process used by the app to display the user-selected county lines or census track lines;

FIG. 11 is a flow diagram depicting a process used by the app to prune the number of counties in which comparison data is mapped and/or compared;

FIG. 12 is a screenshot depicting all counties within a geographic area being depicted in a dynamic map image;

FIG. 13 is a screenshot depicting only 46 selected counties within a geographic area being depicted in the dynamic image after being pruned down from all counties as originally displayed in FIG. 12;

FIG. 14 is a screenshot of tandem first and second dynamic map images providing a side-by-side comparison of different types of data or characteristics for the same geographic area;

FIG. 15 is a screenshot of tandem first and second dynamic map images providing a side-by-side comparison of different cohorts for the same geographic area;

FIG. 16 depicts a screenshot of the app providing toggling map layer options for a second dynamic map image;

FIG. 17 is a screenshot depicting a menu option to change style settings such as data precision, including transparency, point radius, and point blur; and

FIG. 18 is a flow diagram depicting a decision tree for determining if both dynamic map images should receive a change (mirroring) or if only one of the dynamic map images should receive the change in interaction or style.

The drawing figures are for illustration purposes and do not limit the invention to the specific embodiments disclosed and described herein. The drawings are not necessarily to scale, emphasis instead being placed upon clearly illustrating the principles of embodiments of the invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the described invention. The following detailed description is, therefore, not to be taken in a limiting sense. The scope of a particular embodiment of the invention is defined only by the appended claims, along with the full scope of equivalents to which such claims are entitled.

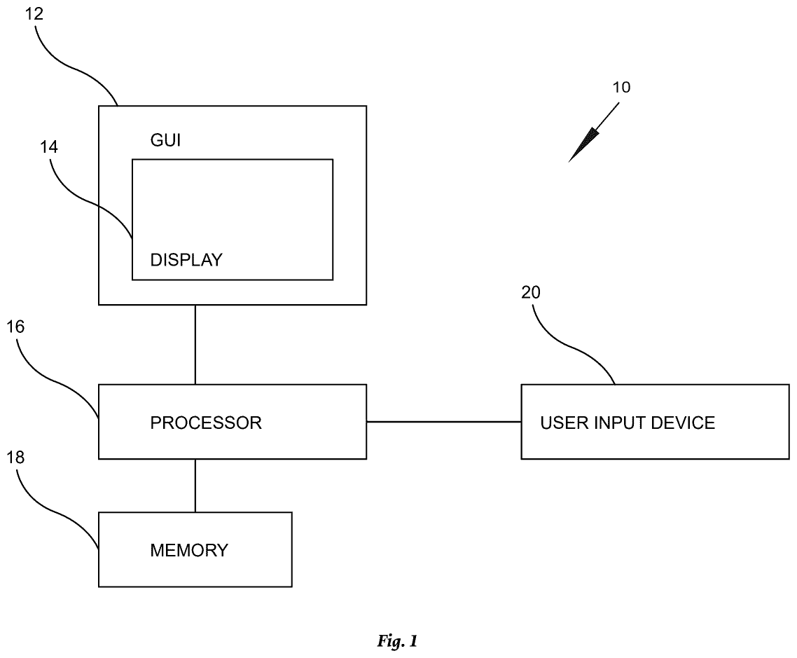

Embodiments of the current invention address one or more of the above-mentioned problems and provide a distinct advance in the art of spatial cohort mapping and analysis. In one or more embodiments of the invention, based on user input and one or more data sources or databases, various data about a particular geographic area can be visually compared in tandem. As depicted in FIG. 1, the technology may include a system 10 having a graphical user interface (GUI) 12, which may include a display screen 14 presenting dynamic images thereon. Dynamic images or dynamic map images as described herein are graphic images in which the visual look and/or information depicted can be manipulated by users in real-time, such as by panning, zooming, highlighting, turning on or turning off various types of data, selecting subregions therein, or making other visual changes thereto. The display screen 14 may be a touch screen configured to receive user input based on user gestures (e.g., a touch from a user finger, a double tap with a user finger, a press and drag of the user finger on the touch screen, etc.), or the system may include a user input device 20 such as a mouse, trackpad, touchpad, a keyboard, a scroll wheel, or the like, as known in the art for manipulating a curser or selection tool on a GUI.

The GUI 12 may include and/or may be communicably coupled with various computer hardware, such as a processor 16 or processors and memory 18 as described below. Furthermore, the GUI 12 and any of the other hardware described herein may be provided electrical power via a power source such as a battery or an electrical cable connectable to an electrical outlet.

In one or more embodiments of the invention, the processor 16 or processors may be configured to execute computer-implemented method steps of any of the methods described herein, and code for executing those method steps may be stored on and accessed from the memory 18 described herein. The computer program or web application (also known as a web app) coded to perform the steps described herein may be a spatial cohort analysis and location explorer app or a spatial cohort mapping and analysis app. The computer program or app described herein may, in some embodiments, be configured to perform a custom phased workflow with emphasis on recuring feedback through a dynamic panel with one or two maps and a summary table, displaying face up contextual information regarding geocoded data points, demographics, population data or averages of population data for a particular geographic area or subregion, or other data associated with specific geographic coordinates and/or geographic areas or subregions (e.g., county or city boundaries). For example, geographic and socioeconomic status of regions may be mapped based on input as the user progresses through each step or each phase of the app. Spatial geography, such as the geographic areas or subregions described herein, may be analyzed at a state, county, zip code, or census tract level in some embodiments, although other more specific study areas can also be analyzed without departing from the scope of the technology described herein. Furthermore, other types of data associated with geographic coordinates or geographic areas or subregions can also be displayed without departing from the scope of the invention herein. For example, in some embodiments, each of the geocoded data points displayed on the GUI 12 may indicate a latitude and longitude associated with a person, place, or event. Other types of data and information displayed on the GUI 12 via the computer program or app are described below.

When used in the medical field, the computer program or app described herein may be deployed to an isolated network with the necessary controls in place for Health Insurance Portability and Accountability Act (HIPAA) compliance or other types of desired compliance (e.g., industry standards, other types of government compliance, or the like) and may support standard authentication and authorization protocols (e.g., OpenID, OAuth 2.0) to ensure secure access to data resources. The computer program or app may also display data point locations on a map based on cohort participants' addresses in geocoded format. The computer program or app may provide the opportunity to display place-based and cohort-based data by selecting the analysis and type and using data provided in a cohort participant location file uploaded to the computer program or app. In one example embodiment, the computer program or app implements a standard and accessible method of evaluating equity in recruitment in research studies using place-based data displayed with custom geographic information system (GIS) software. In some embodiments, the cohort is a group of participants in a research study. In other embodiments, the cohort is a group of persons who have been treated by a healthcare organization. Furthermore, in some embodiments the cohort is a group of persons who share membership with an organization.

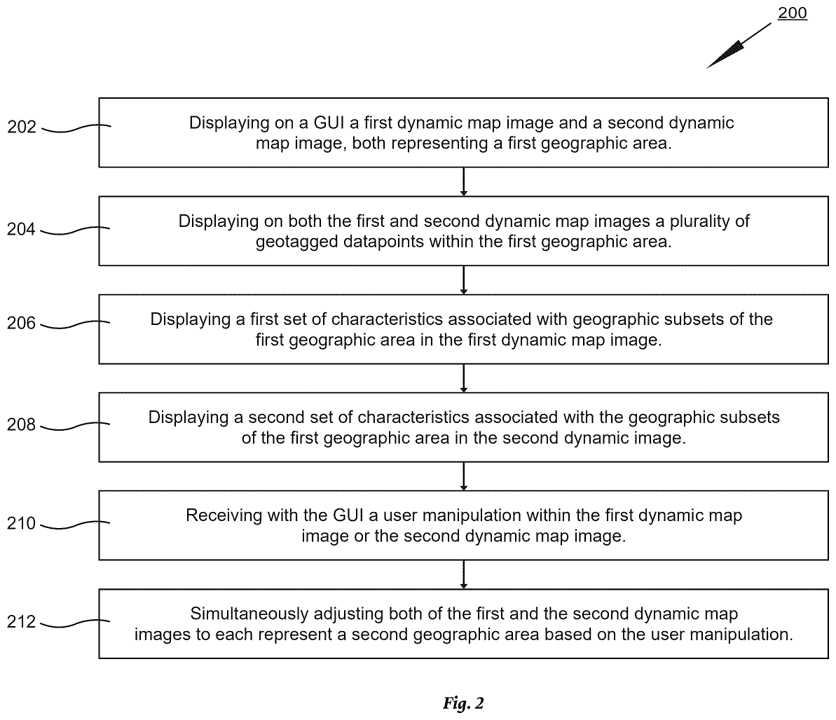

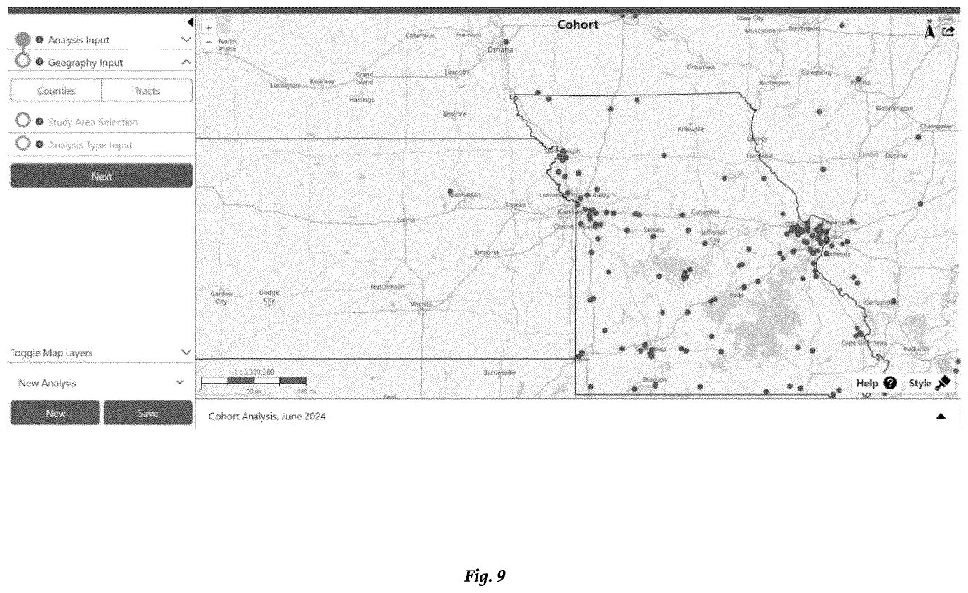

The method steps implemented via the computer program or app described above may be configured for tandem map displays, with an exemplary method 200 as depicted in FIG. 2 comprising the step of displaying on a GUI a first dynamic map image and a second dynamic map image on a screen (e.g., the display screen 14 of the GUI 12), as depicted in block 202. Both the first and the second dynamic map images may represent a first geographic area, for example. The first geographic area may be user-selected via one or more of the tool icons of user gestures associated with highlighting, circling, or otherwise selecting a specific geographic area, and may be selected based on a menu item labeled Geography Input, as in FIG. 9 described below. Note that in some embodiments, the step in block 202 may occur later on, and only the first dynamic map is displayed initially, while the second dynamic map may appear on the GUI's display screen 14 once other steps described herein have been performed (such as identifying what information or characteristics are to be compared).

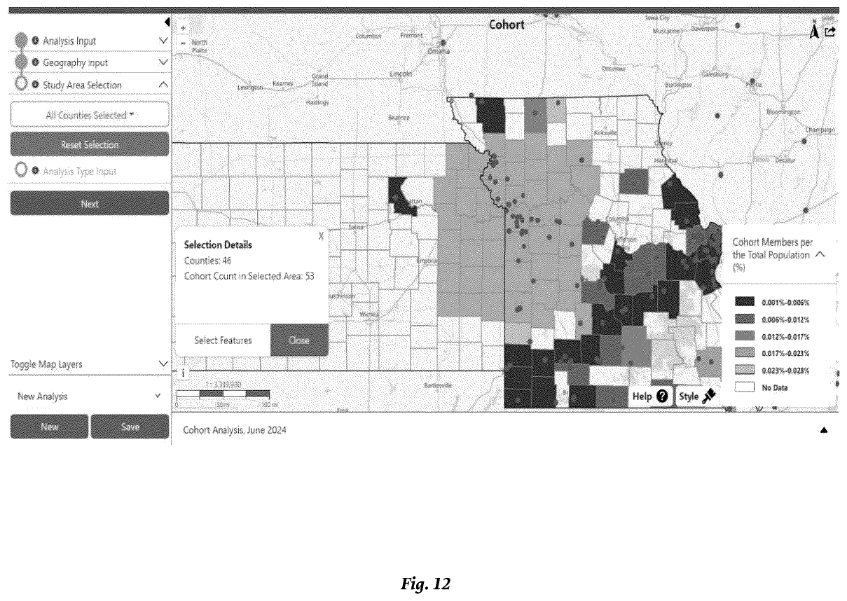

The method 200 may also include a step of displaying on both of the first and the second dynamic map images a plurality of geocoded data points, each at a particular geographic coordinate within the first geographic area, as depicted in block 204. In some embodiments, each of the geocoded data points indicate a latitude and longitude associated with a person, place, or event. For example, as in the screen shot depicted in FIG. 12, the red dots each are representative of people, specifically patients involved in a study, and are placed at the latitude and longitude of each patient's address. (Please note that the locations indicated by the red dots in FIG. 12 or any of the figures herein are merely exemplary and do not represent any actual patient addresses.) The geocoded data points can also be depicted using color gradients or heat maps by changing various levels of transparency, point radius, and point blur, for example, more readily visually depicting areas with many of the geocoded points (e.g., many patients or cohort participants). For example, the data points described herein can include blurred data points that are each blurred to preserve privacy regarding details of that geocoded data point's particular geographic coordinates.

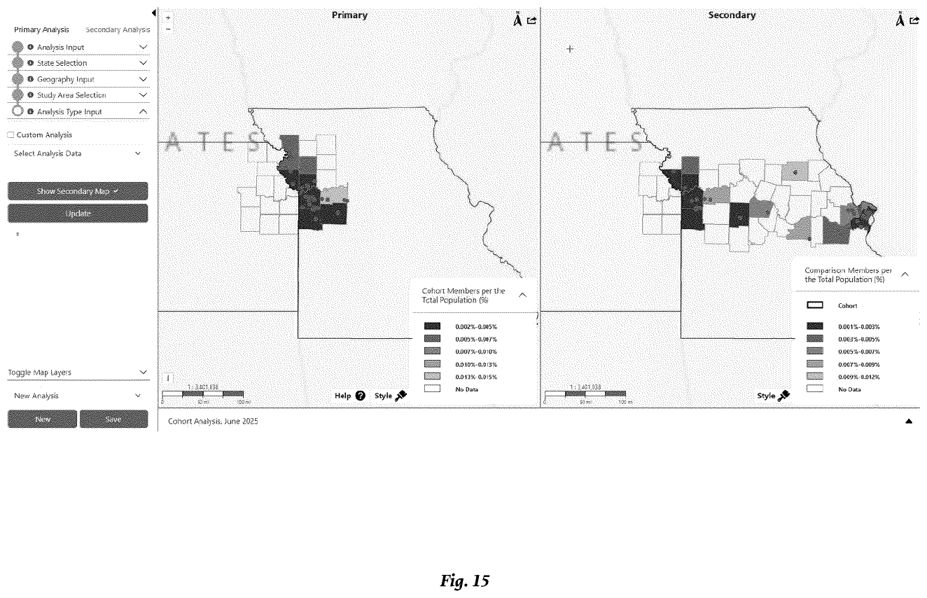

Furthermore, the method 200 may include the steps of displaying a first set of characteristics associated with geographic subsets (e.g., counties or city boundaries) of the first geographic area in the first dynamic map image, as depicted in block 206, and displaying a second set of characteristics associated with the geographic subsets (e.g., the counties or city boundaries) of the first geographic area in the second dynamic map image, as depicted in block 208. In some embodiments, as depicted in FIG. 15, the first set of characteristics and/or the second set of characteristics may use color-coding or pattern-coding representative of population characteristics for each of a plurality of the geographic subsets within the first geographic area or any geographic region described herein. The colors or patterns representative of population characteristics may include a color gradient or heat map with various levels of transparency, point radius, and point blur, for example, such as when providing a heat map indicating areas of high and low population or high or low income throughout the geographic area or subregions thereof. The population characteristics may include any of the following: population density, socioeconomic status, race, ethnicity, gender, age, marital status, sexuality, religion, and political affiliation. In one example embodiment, as depicted in the second dynamic map image in FIG. 15, the population characteristics displayed therein is the percent of population with a low income. In some example embodiments, the population characteristics may be based on cohort participant data, such as the percentage of cohort members or participants per the total population. Other sets of characteristics or population characteristics may include percent minoritized population, low-income status, poverty, medical coverage type, or rural status, for example. Alternatively, instead of population characteristics, the set of characteristics on the first and/or second dynamic map image may include other geographically-related characteristics of the geographic area or subregion, such as traffic, particular animal populations, plant life in particular geographic areas, or any other data found in a database that associates said data with a geographic coordinate and/or a specific geographic area or subregion.

The method 200 may also include the step of receiving with the GUI 12 and/or the user input device 20 a user manipulation within the first dynamic map image or the second dynamic map image, as depicted in block 210. This may include receiving with the GUI 12 a user selection of one of a plurality of tool icons and/or receiving with the GUI 12 a user manipulation of the user input device 20 when the cursor is within the first dynamic map image or the second dynamic map image. Then, as a result of the step depicted in block 210, the method 200 may include a step of simultaneously adjusting both of the first and the second dynamic map images to each represent a second geographic area based on the user manipulation, as depicted in block 212. In some embodiments, the user manipulation is a magnification tool or magnification user gesture configured to enlarge a subset of any geographic areas displayed on the first and second dynamic map images simultaneously. Additionally or alternatively, the user manipulation may include a panning tool or panning user gesture configured to shift the first and second dynamic map images in any direction from the first geographic area to the second geographic area simultaneously. In some embodiments, step 212 may further include updating one or more study areas listed, and the information associated therewith, on comparison tables described herein. For example, side-by-side comparison tables may be displayed and dynamically updated based on user selection within one of the dynamic map images and/or based on user input within one of the comparison tables.

For example, a user may use a cursor to select a magnification tool and may click on a location with the first dynamic map image, and the geographic area displayed in both the first and the second dynamic map image can simultaneously change to a second geographic area that is a zoomed in version of the first geographic area. Additionally or alternatively, the user may use the cursor to select a panning tool and may click and slide in any direction within the second dynamic map image, and the geographic area displayed in both the first and the second dynamic map images can simultaneously change to an alternative second geographic area that is at least partially outward of the boundaries of the first geographic area (e.g., North, South, East, or West of the first geographic area). However, while the geographic areas displayed in both the first and the second dynamic map images remain identical, the sets of characteristics overlayed onto those maps may still remain different and be based on different data sets. Specifically, the first set of characteristics and the second set of characteristics associated with geographic subsets of the second geographic area may be displayed in the first dynamic map image and the second dynamic map image, respectively.

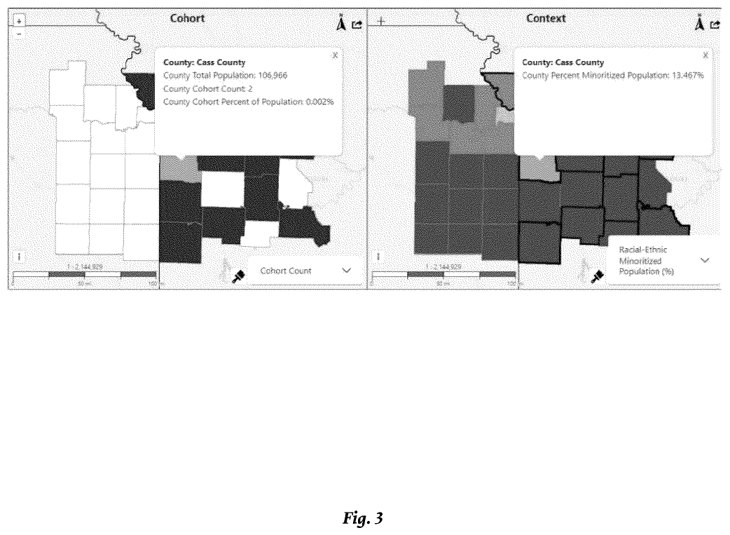

In some embodiments, the user manipulation may be a predefined user gesture on a touchpad, trackpad, or touchscreen instead of selection of a magnification or panning icon. For example, pinch-to-zoom magnification may use a thumb and forefinger of the user, starting close together on the touchpad, for example (once the cursor is in a desired zoom point on a map), and sliding each away from each other on the touchpad. Likewise, the panning on a touchscreen may merely require a touch and slide on the desired dynamic map image using a single finger to pan without selection of a panning tool. Furthermore, in some embodiments, the computer program or app may be configured such that tapping on a specific subregion or data point on one of the first or second dynamic map images may present a pop-up screen displaying information regarding a name of the subregion, data points, characteristics, or the like on both the first and the second dynamic map images. For example, as depicted in the example screenshot of FIG. 3, Cass County is highlighted and a pop-up screen appears on the first and second dynamic map images, but one of those pop-ups includes the total population along with other data, while the other pop-up includes only the county percent minoritized population.

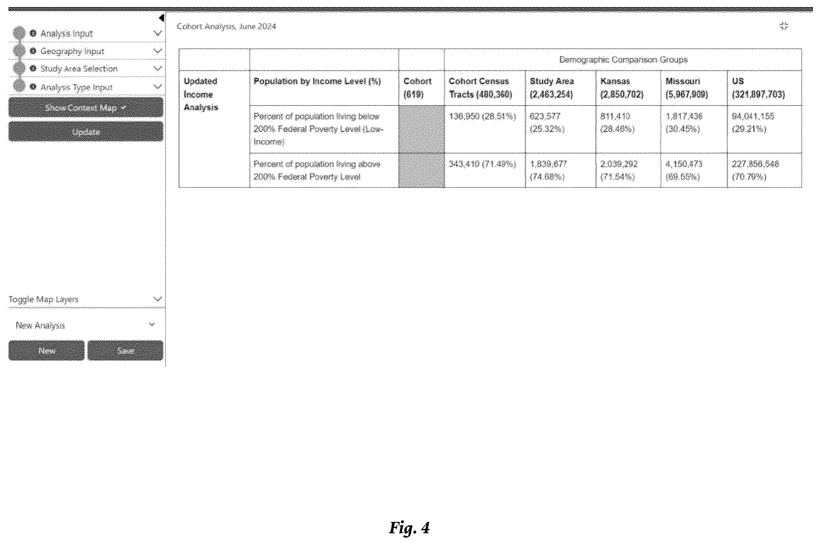

In some embodiments, in addition to the tool icons and/or the first and second dynamic map images, the GUI 12 may present charts or tables providing side-by-side comparison of the information displayed in the first and second dynamic map images, including only what is visually depicted in the geographic area displayed in real time on the GUI 12 (e.g., the first geographic area or the second geographic area). In some embodiments, the data being compared in the tables or charts may be presented without the maps based on specific user selections, as depicted in the example screenshot of FIG. 4.

Thus, when the GUI 12 receives user selections causing the zooming or panning described above, the first set of characteristics and the second set of characteristics associated with geographic subsets of the second geographic area are shown in the first and second dynamic map images, respectively. This tandem manipulation of at least two different dynamic map images, such that the geographic area displayed and geographic locations of data points in a cohort displayed are always identical, while each of the dynamic map images simultaneously also display different types of characteristics associated with geographic subsets within the geographic area being displayed for both dynamic map images allows for geographic inference or dynamic visual analysis and comparison of two, three, or more data sets within a plurality of geographic areas without overlapping too many types of data and obscuring important information.

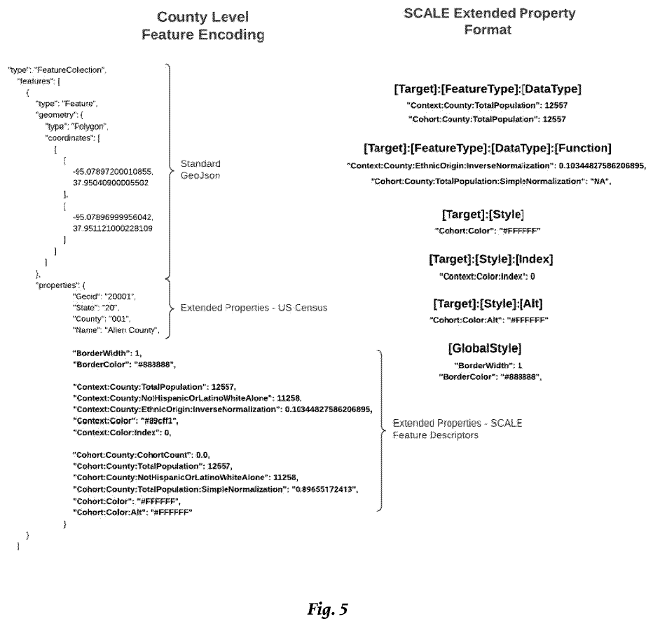

FIGS. 5-21 depict an overview of an exemplary logic and/or associated screenshots that enable the computer program or app to transmit contextual data in an indexed format that a custom UI model can unpack and display on one or more maps as described above. For example, as depicted in FIG. 5 county-level feature encoding demonstrates how data is indexed with composite keys that describe how the data should be interpreted and displayed. The Extended Property Format provides examples of the composite index format and what each section of the index indicates for the client module to interpret.

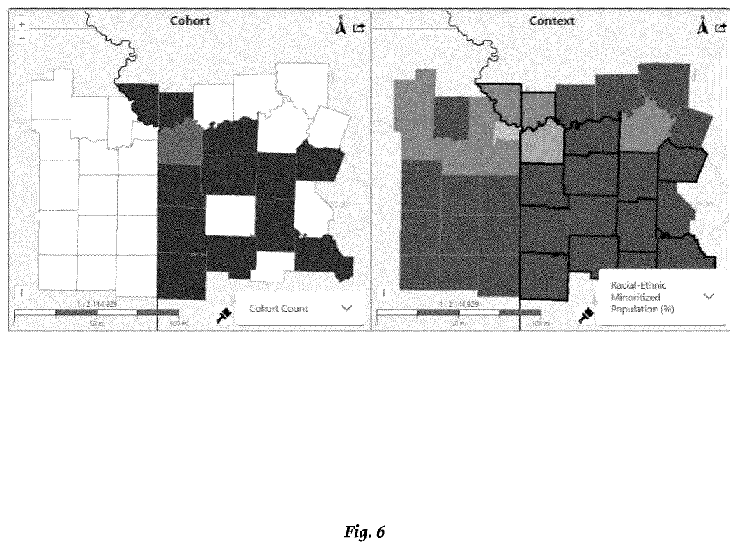

Map gradient options for user customization may be stored as a keyed collection of hex value color arrays, as depicted in FIG. 6. Furthermore, a user's gradient selection may be sustained through a lifecycle of an analysis session and through analysis saving, by storing a composite index corresponding to this key, and the target map for the gradient. Map data may be returned to the client or user as extended properties or descriptors for individual geographies, adhering to the previously-defined grammar for the extended property format. The composite indexes for data may follow this example index hierarchy: [Target]:[Geography]:[Data Type]:[Function].

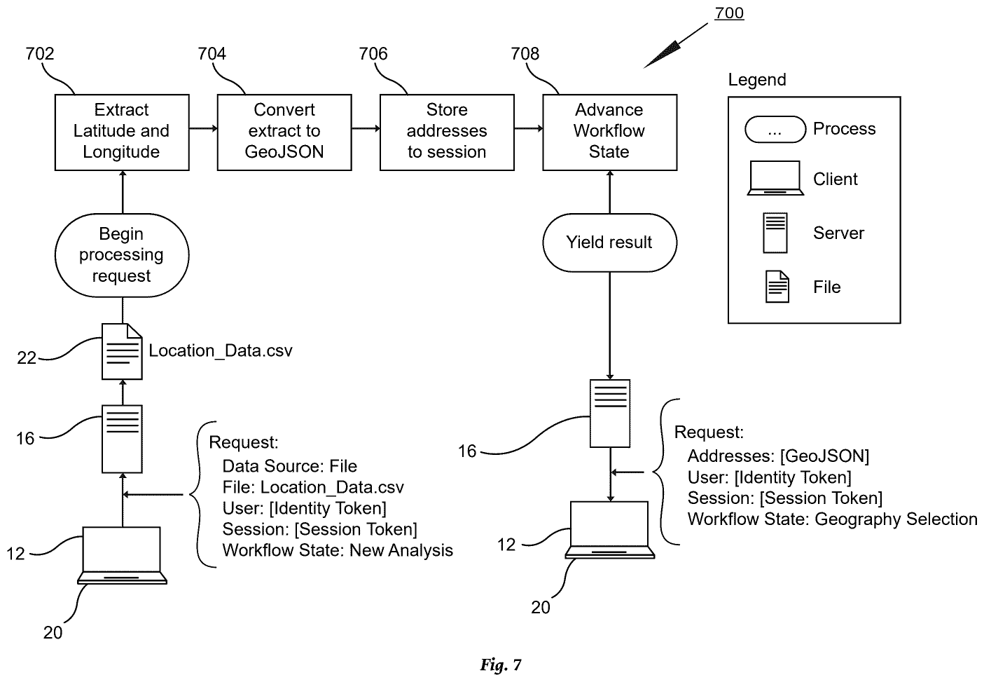

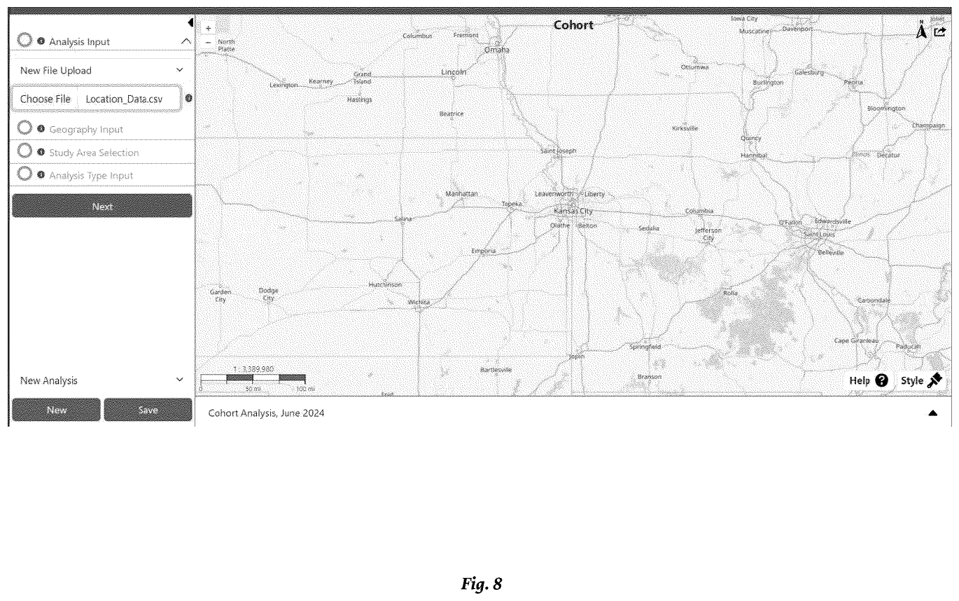

In some embodiments, as depicted in the flow chart of FIG. 7 and the screenshot of FIG. 8 a user may upload a geocoded file 22 of cohort participant locations as a collection of latitudes and longitudes, along with optional entries for participant race and ethnicity. For example, as depicted in FIG. 7, a method 700 may include the latitude and longitude may being extracted, as depicted in block 702, the extracted data being converted to a desired data type (e.g., GeoJSON), as depicted in block 704, the addresses being stored for that particular session, as depicted in block 706, and the workflow advancing to the next state, as depicted in block 708. The next state may be, for example, “Geography Input” as displayed in a workflow listing in FIG. 8. Locations may be mapped without any additional place-based context.

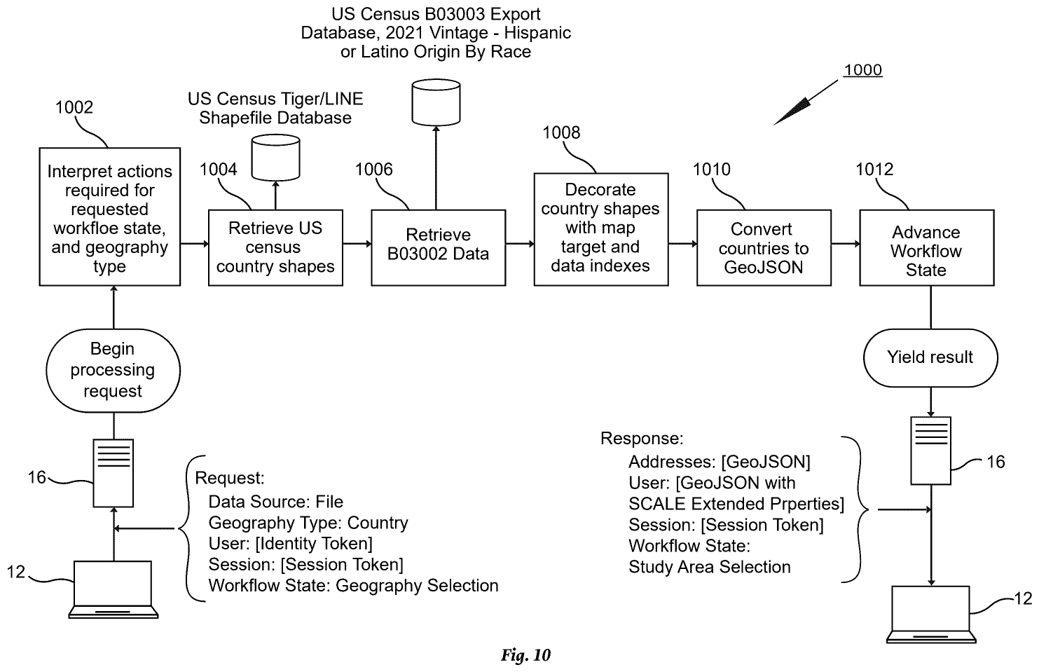

In some embodiments, the workflow may also ask a user to indicate what geography input is being analyzed, such as counties or census tracts, as depicted in the screenshot of FIG. 9 (e.g., during the “Geography Input” workflow) and the flow chart of FIG. 10, which depicts a method 1000. Based on the user's selection, geography shapes may be plotted on the first and/or the second dynamic map images. The exemplary method 1000 may include, for example, the steps of interpreting actions required for requested workflow state and geography type, as depicted in block 1002, retrieving US census county shapes, as depicted in block 1004, and retrieving other data (e.g., race or nationality) for those regions, as depicted in block 1006. The method 1000 may further include decorating county shapes with map target and data indexes, as depicted in block 1008, converting counties to a desired file format (e.g., GeoJSON), as depicted in block 1010, and advancing the workflow to the next state, as depicted in block 1012.

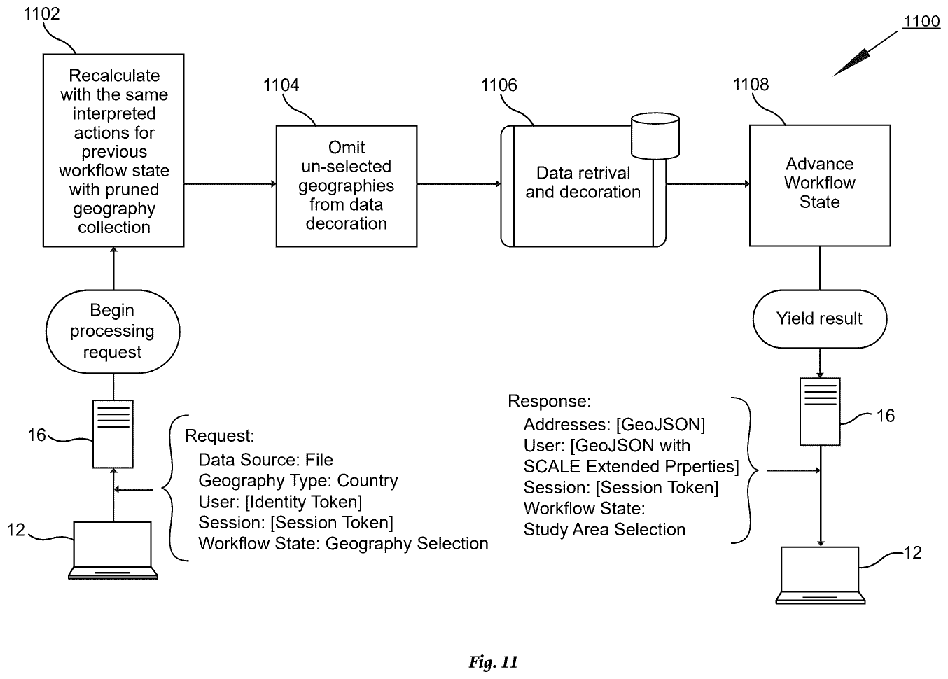

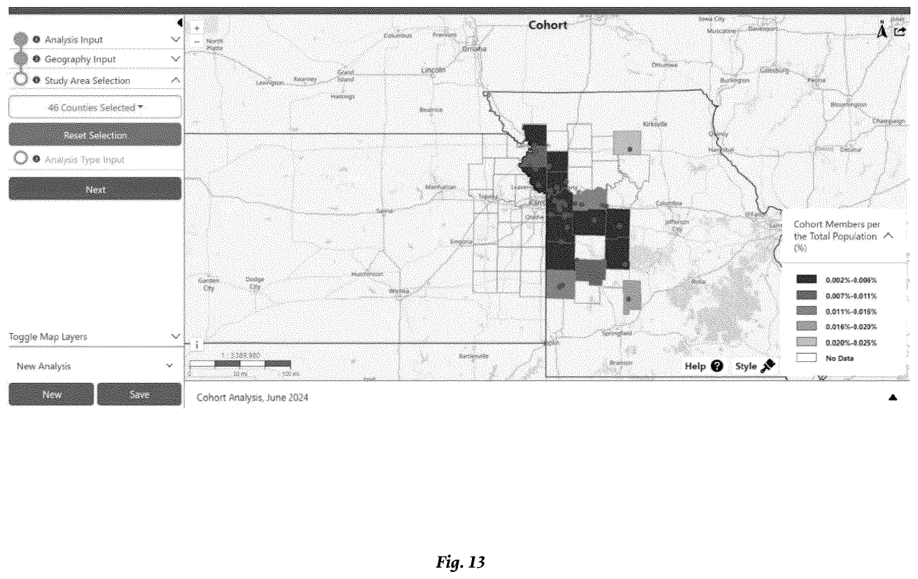

Then, as depicted in FIGS. 11-13, geography pruning may allow a user to narrow geography areas mapped down to a smaller subregion and/or to pan over to a different geographic area available for analysis. For example, the flow chart in FIG. 11 depicts a process 1100 for pruning from all counties (see FIG. 12 before pruning) to 46 selected counties (see FIG. 13 after pruning). Specifically, the process 1100, as depicted in FIG. 11, may include recalculating with the same interpreted actions for previous workflow states with pruned geography collection, as depicted in block 1102, omitting unselected geographies from data decoration, as depicted in block 1104, retrieving resulting data and decorating the one or more maps accordingly, as depicted in block 1106, and then advancing the workflow state, as depicted in block 1108.

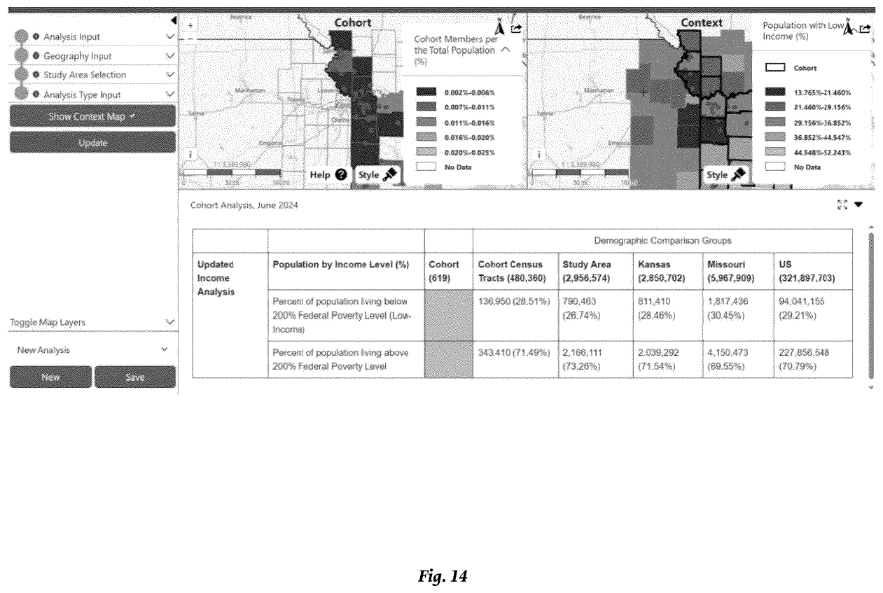

This selection of the study area or pruning as described above may also affect the comparison table depicted in FIG. 4, for example, which may include a column for “Study Area,” for example. This may be performed via the user gestures and/or the tool icons described above. Subsequently, an analysis type selection may be made by the user, thereby instructing the computer program or app to obtain contextual information for comparing place-based socioeconomic data, such as low income status, for example, with respect to the distribution of a cohort (e.g., the individuals involved in a particular study). This may then allow for the side-by-side comparison of two different maps of the same geographic area as depicted in FIG. 14 (e.g., comparing the cohort in a map on the left and total population economics within those same geographic regions in a map on the right). These dynamic map images may in tandem be zoomed in and out and/or panned and/or may have a subregion thereof highlighted for further comparison and analysis, as described above, while still comparing different characteristics associated with the geographic subregions being displayed therein.

Some embodiments herein can be configured for cohort comparisons as follows. For example, as depicted in FIG. 15, a user is allowed to enter two distinct cohorts to be compared with each other on the same geographical area. In this embodiment, one set of cohorts can be displayed on the left map and another set of cohorts can be assigned to the right map. This ability allows users to analyze a cohort with respect to another cohort in the same session. This feature will also enable users to compare two cohorts with publicly available datasets for socioeconomic analysis. In some embodiments, the two different sets of cohorts can be sub-cohorts of one total cohort in a study (e.g., two different sub-cohorts recruited using separate address collection techniques). Advantageously, this feature enables comparisons of two address lists with respect to each other without the need to switch windows. Specifically, in some embodiments, changes made to the distribution of data and/or geographicarea viewed on one map is automatically reflected on the other map.

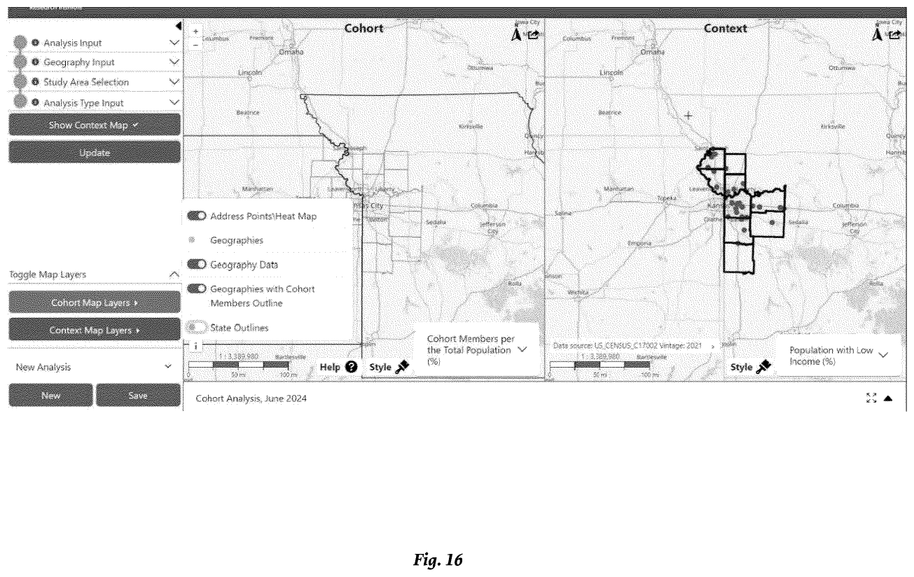

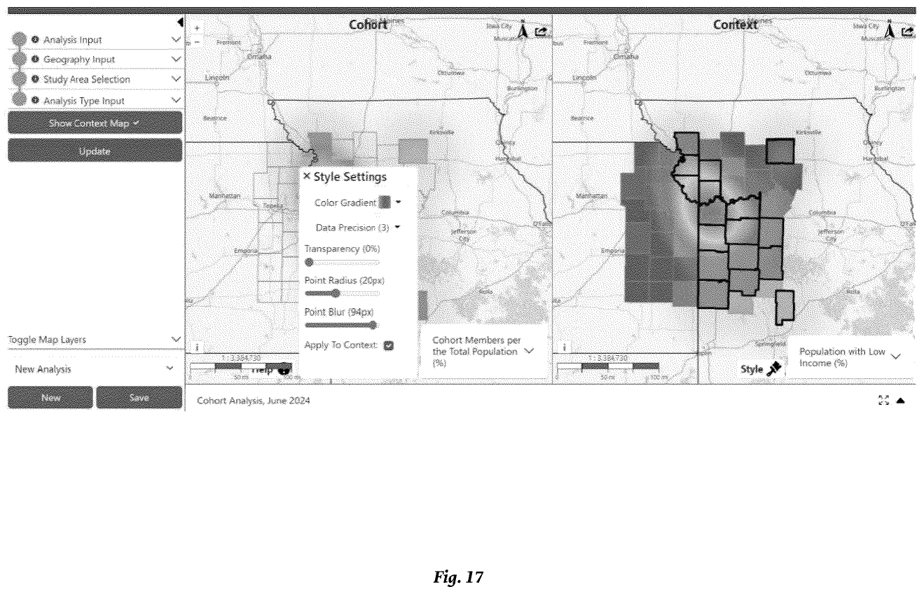

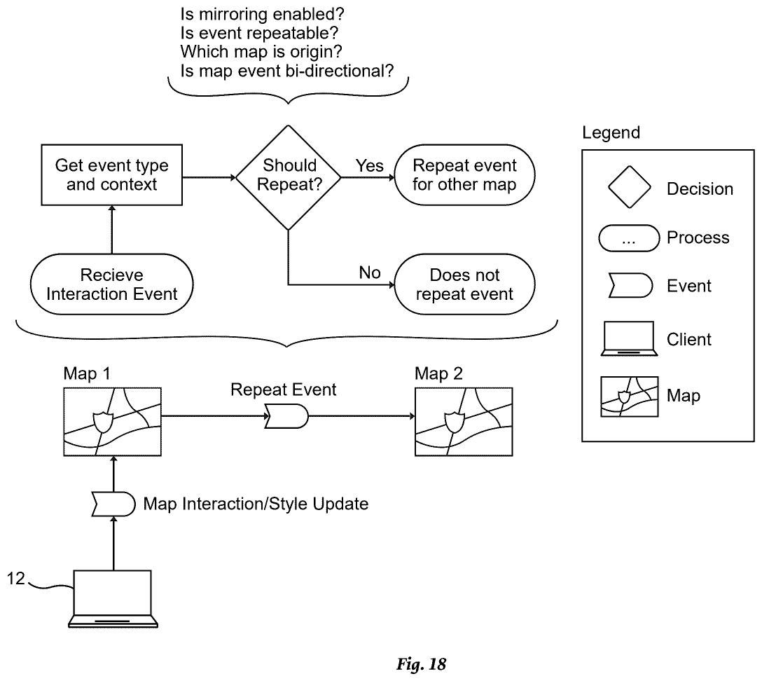

As depicted in FIGS. 16-17, stylization and customization components for the maps may offer users with various options to toggle map layers (e.g., turning layers of mapped data on and/or off as in FIG. 16), adjust data precision and styles, and/or customize color gradient, transparency, point radius, and point blur, as in FIG. 17. A flow chart depicting an example method flow to be followed by the computer program or app in one or more embodiments herein is depicted in FIG. 18. For example, if a zoom event occurs on a left map displayed and mirroring is enabled, the zoom event is automatically repeated on a right map displayed. This and other events or settings may selectively be mirrored for one or both maps displayed in various embodiments herein.

In some embodiments, the computer program or app may provide options to save an analysis. This saved analysis may be associated to the identity of a user signed in through an authentication and authorization system, for example. Furthermore, in some embodiments, a help menu may be made available for face up guidance to a user, providing access to user-selectable topics to read about and/or various computer program or app instructions. Additionally or alternatively, the help topics may be found by a user based on keywords or questions entered by the user in a help menu search bar.

Additional advantages of the various embodiments of the invention will be apparent to those skilled in the art upon review of the disclosure herein. It will be appreciated that the various embodiments described herein are not necessarily mutually exclusive unless otherwise indicated herein. For example, throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processor's processing elements need not be configured or instantiated at any one instance in time. For example, where the processor comprises a general-purpose processor configured using software, the general-purpose processor may be configured as respective different processing elements at different times. Software may accordingly configure the processor to constitute a particular hardware configuration at one instance of time and to constitute a different hardware configuration at a different instance of time.

Computer hardware components, such as communication elements, memory elements (e.g., the memory 18), processors (e.g., the processor 16), processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled in a wired or wireless manner (such as via web-based, cloud-based, or internet-based communication and processing tools and standards). A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements or processors that are temporarily configured (e.g., by software) or permanently configured to perform the relevant operations. Whether temporarily or permanently configured, such processing elements or processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processing elements, processors, or processor-implemented hardware modules. The performance of certain of the operations may be distributed among the one or more processing elements or processors, not only residing within a single machine, but deployed across a number of machines. In some example embodiments, the processing elements or processors may be located in a single location (e.g., within a home environment, an office environment or as a server farm), while in other embodiments the processing elements or processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element or processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the phrase “and/or,” when used in a list of two or more items, means that any one of the listed items can be employed by itself or any combination of two or more of the listed items can be employed. For example, if a component or system is described as containing or excluding components A, B, and/or C, the component or system can contain or exclude A alone; B alone; C alone; A and B in combination; A and C in combination; B and C in combination; or A, B, and C in combination.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A computer-implemented method for tandem map displays, the method comprising:
displaying via a graphical user interface (GUI) a first dynamic map image and a second dynamic map image on a screen of the GUI, wherein both the first and second dynamic map images each represent a first geographic area;
displaying on both of the first and the second dynamic map images a plurality of geocoded data points, each at a particular geographic coordinate within the first geographic area;
displaying a first set of characteristics associated with geographic subsets of the first geographic area in the first dynamic map image;
displaying a second set of characteristics associated with the geographic subsets of the first geographic area in the second dynamic map image;
receiving with the GUI a user manipulation within the first dynamic map image or the second dynamic map image; and
simultaneously adjusting both of the first and the second dynamic map images to each represent a second geographic area based on the user manipulation, wherein the first set of characteristics and the second set of characteristics associated with geographic subsets of the second geographic area are displayed in the first dynamic map image and the second dynamic map image respectively.

2. The computer-implemented method of claim 1, wherein the user manipulation is a magnification gesture or a user manipulation of a magnification icon which zooms into a subsection of the first geographic area on the first and second dynamic map images simultaneously or a panning gesture or a user manipulation of a panning tool which shifts the first and second dynamic map images simultaneously in any direction from the first geographic area to the second geographic area.

3. The computer-implemented method of claim 1, wherein the user manipulation received with the GUI comprises an indication of one or more touches on a touch screen, wherein the touch screen is configured to receive physical touch and to manipulate the dynamic images in response to the physical touch.

4. The computer-implemented method of claim 1, wherein one or more of the plurality of geocoded data points is depicted as blurred to preserve privacy regarding details of the particular geographic coordinate.

5. The computer-implemented method of claim 1, wherein the first set of characteristics and the second set of characteristics uses color-coding or pattern-coding representative of population characteristics for each of a plurality of the geographic subsets within the first geographic area.

6. The computer-implemented method of claim 1, wherein the population characteristics include any of the following: population density, socioeconomic status, race, ethnicity, gender, age, marital status, sexuality, religion, and political affiliation.

7. The computer-implemented method of claim 1, further comprising displaying a chart or comparison table comprising information depicted in the first dynamic map image and the second dynamic map image.

8. A system for tandem map displays, the system comprising:
a graphical user interface (GUI) having a screen configured to display dynamic images and a user input device communicably coupled to the screen and configured to manipulate the dynamic images on the screen; and
a processor communicably coupled with the GUI and programmed to:
display a first dynamic map image and a second dynamic map image on the screen of the GUI, wherein both the first and second dynamic map images each represent a first geographic area;
display on both of the first and the second dynamic map images a plurality of geocoded data points, each at a particular geographic coordinate within the first geographic area;
display a first set of characteristics associated with geographic subsets of the first geographic area in the first dynamic map image;
display a second set of characteristics associated with the geographic subsets of the first geographic area in the second dynamic map image;
receive with the GUI via a user manipulation of the user input device, wherein the user manipulation is associated with at least one of magnifying, zooming, panning, or selecting at least a portion of the first dynamic map image or the second dynamic map image; and
simultaneously adjusting both of the first and the second dynamic map images to each represent a second geographic area based on the user manipulation, wherein the first set of characteristics and the second set of characteristics associated with geographic subsets of the second geographic area are displayed in the first dynamic map image and the second dynamic map image respectively.

9. The system of claim 8, wherein at least one of the screen and the user input device comprise a touch screen configured to receive physical touch and to manipulate the dynamic images in response to the physical touch. 10 The system of claim 8, wherein the user manipulation received with the GUI is a magnification gesture or a user manipulation of a magnification icon which zooms into a subsection of the first geographic area on the first and second dynamic map images simultaneously or a panning gesture or a user manipulation of a panning tool which shifts the first and second dynamic map images simultaneously in any direction from the first geographic area to the second geographic area.

11. The system of claim 8, wherein each of the geocoded data points indicate a latitude and longitude associated with a person, place, or event.

12. The system of claim 8, wherein the first set of characteristics and the second set of characteristics are displayed via color-coding or pattern-coding representative of population characteristics for each of a plurality of the geographic subsets within the first geographic area.

13. The system of claim 8, wherein the population characteristics include any of the following: population density, socioeconomic status, race, ethnicity, gender, age, marital status, sexuality, religion, and political affiliation.

14. The system of claim 8, wherein the processor is further programmed to display a chart or comparison table comprising information depicted in the first dynamic map image and the second dynamic map image.

15. A non-transient computer-readable medium comprising program instructions configured for causing a computer to perform the following steps:
displaying via a graphical user interface (GUI) a first dynamic map image and a second dynamic map image on a screen of the GUI, wherein both the first and second dynamic map images each represent a first geographic area;
displaying on both of the first and the second dynamic map images a plurality of geocoded data points, each at a particular geographic coordinate within the first geographic area;
displaying a first set of characteristics associated with geographic subsets of the first geographic area in the first dynamic map image;
displaying a second set of characteristics associated with the geographic subsets of the first geographic area in the second dynamic map image;
receiving with the GUI a user manipulation within the first dynamic map image or the second dynamic map image; and
simultaneously adjusting both of the first and the second dynamic map images to each represent a second geographic area based on the user manipulation, wherein the first set of characteristics and the second set of characteristics associated with geographic subsets of the second geographic area are displayed in the first dynamic map image and the second dynamic map image respectively.

16. The non-transient computer-readable medium of claim 15, wherein the user manipulation is a magnification gesture or a user manipulation of a magnification icon which zooms into a subsection of the first geographic area on the first and second dynamic map images simultaneously or a panning gesture or a user manipulation of a panning tool which shifts the first and second dynamic map images simultaneously in any direction from the first geographic area to the second geographic area.

17. The non-transient computer-readable medium of claim 15, wherein each of the geocoded data points indicate a latitude and longitude associated with a person, place, or event.

18. The non-transient computer-readable medium of claim 15, wherein the first set of characteristics and the second set of characteristics uses color-coding or pattern-coding representative of population characteristics for each of a plurality of the geographic subsets within the first geographic area.

19. The non-transient computer-readable medium of claim 15, wherein the population characteristics include any of the following: population density, socioeconomic status, race, ethnicity, gender, age, marital status, sexuality, religion, and political affiliation.

20. The non-transient computer-readable medium of claim 15, further comprising program instructions configured for causing a computer to display a chart or comparison table comprising information depicted in the first dynamic map image and the second dynamic map image.
